(19) United States
(12) Patent Application Publication
(10) Pub. No.: US 2014/0332171 A1
(43) Pub. Date: Nov. 13, 2014

(54) Door Structure

(71) Applicant: Clifford OLSEN, Lacombe (CA)

(72) Inventor: Clifford OLSEN, Lacombe (CA)

(21) Appl. No.: 14/271,850

(22) Filed: May 7, 2014

(30) Foreign Application Priority Data
May 7, 2013 (CA) 2815329

(51) Int. Cl. E06B 3/44; E06B 1/52; E05D 15/16; E06B 1/70

(52) U.S. Cl. CPC E06B 3/4415; E06B 1/70; E06B 1/52; E05D 15/16
USPC 160/118

(57) ABSTRACT

A door structure is described which includes a door frame having a threshold. The door frame encloses an upper door section and a lower door section. An upper door guide track guides movement of the upper door section between a closed position enclosing the upper portion of the door frame and an open position moved upwardly clear of the door frame. A lower door guide track guides movement of the lower door section between a closed position enclosing the lower portion of the door frame and an open position moved downwardly into the threshold clear of the door frame. The upper door section and the lower door section are independently operable to enable the lower door section to remain in the open position while the upper door section remains in the closed position.

### FIELD

There is described a door structure that was developed to address problems with aircraft hangar doors, it will be appreciated that this door structure may be applicable to other installations, such as doors on loading bays of warehouses.

### BACKGROUND

Doors on aircraft hangars are viewed as being inefficient. They take time to open and close. When fully open they allow for a substantial heat loss from the hangar. There will hereinafter be described an alternative door structure.

### SUMMARY

There is provided a door structure which includes a door frame having a threshold. The door frame accommodates an upper door section and a lower door section. An upper door guide track guides movement of the upper door section between a closed position enclosing an upper portion of the door frame and an open position moved upwardly clear of the door frame. A lower door guide track guides movement of the lower door section between a closed position enclosing a lower portion of the door frame and an open position moved downwardly into the threshold clear of the door frame. The upper door section and the lower door section are independently operable to enable the lower door section to remain in the open position while the upper door section remains in the closed position.

The door structure, as described above, provides a number of advantages for aircraft hangars and will provide similar advantages for doors of other structures. The upper door section can be maintained in the closed position, except for those rare occasions when additional height clearance is required to move a large aircraft or a tall piece of equipment. With the upper door section maintained in the closed position, the lower door section can be left in the open position or selectively moved to the open position to enable small aircraft, vehicles, equipment and supplies to be moved in and out of the aircraft hangar.

The lower door can be recessed down into the threshold, leaving a gap in the threshold. It is preferred, however, that an upper edge of the lower door section becomes a travel portion of the threshold when in the open position.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front elevation view of a building with a door structure with an upper door section and a lower door section in a closed position.

FIG. 2 is a front elevation view of the building shown in FIG. 1 with the lower door section in the open position.

FIG. 3 is a front elevation view of the building shown in FIG. 1 with the upper door section and the lower door section in the open position.

FIG. 4 is a top plan view of a threshold of the door frame for the door structure illustrated in FIG. 1.

FIG. 5 is an end elevation view, in section, of the threshold illustrated in FIG. 4.

### DETAILED DESCRIPTION

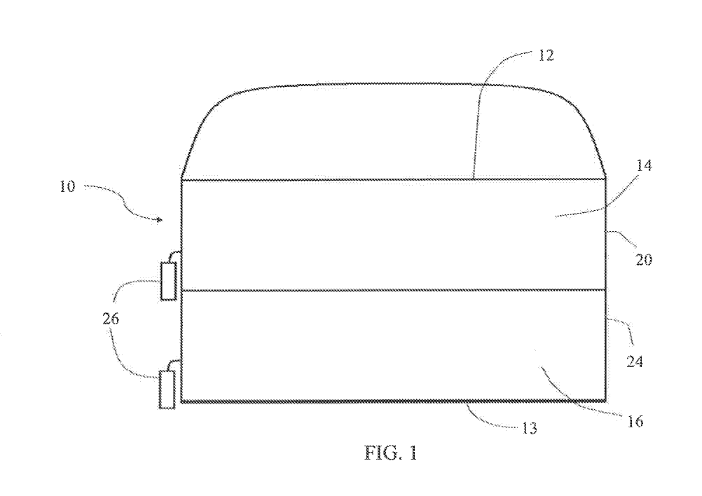

A door structure generally identified by reference numeral 10, will now be described with reference to FIG. 1 through 5.

### Structure and Relationship of Parts:

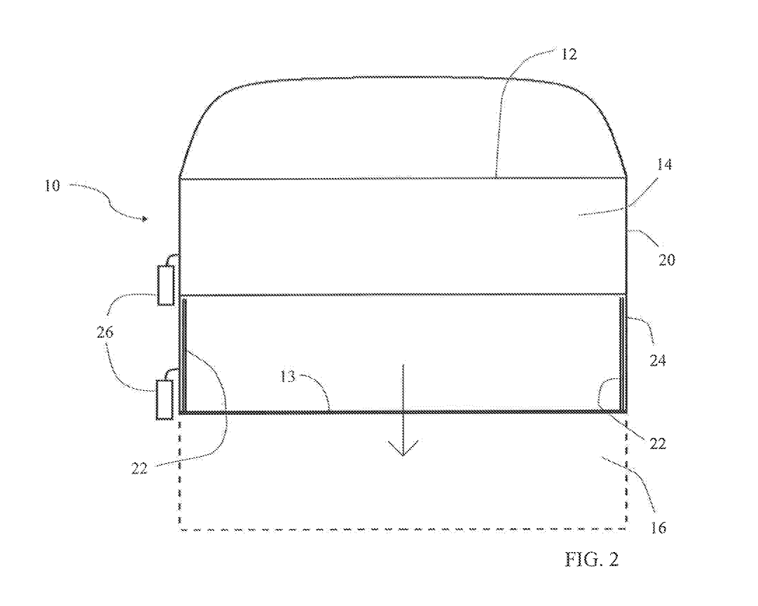

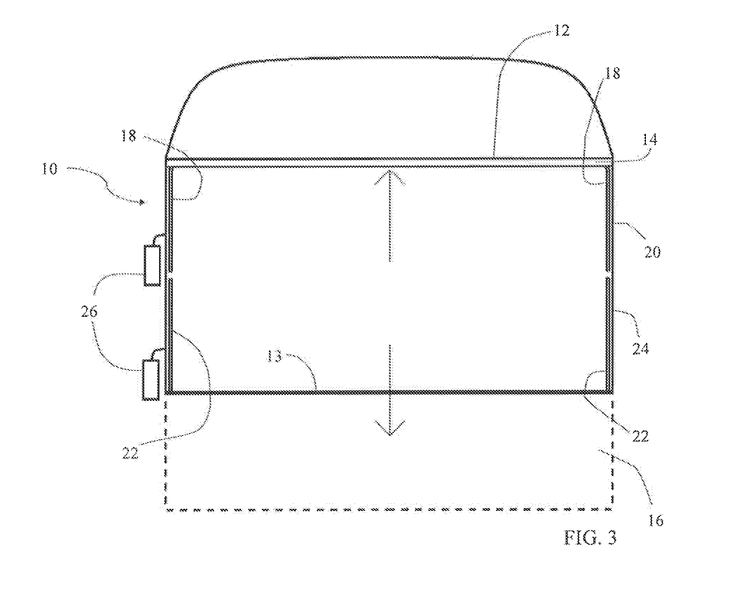

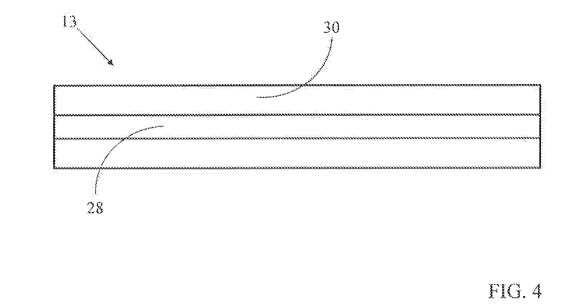

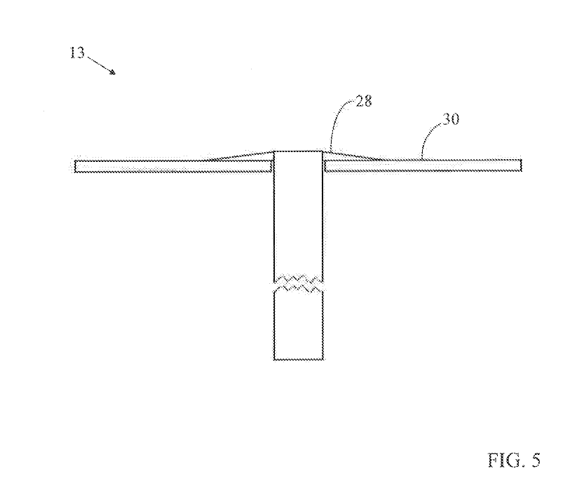

Referring to FIG. 1, a door structure 10 has a door frame 12 which has a threshold 13. Door frame 12 encloses an upper door section 14 and a lower door section 16. Referring to FIG. 3, an upper door guide track 18 guides movement of upper door section 14 between a closed position, shown in FIG. 1, and an open position, shown in FIG. 3. Referring to FIG. 1, in the closed position, upper door section 14 encloses an upper portion 20 of door frame 12. Referring to FIG. 3, in the open position, upper door section 14 is moved upwardly clear of door frame 12. Referring to FIG. 2, a lower door guide track 22 guides movement of lower door section 16 between a closed position, shown in FIG. 1, and an open position, shown in FIG. 2 and FIG. 3. Referring to FIG. 1, in the closed position, lower door section 16 encloses a lower portion 24 of door frame 12. Referring to FIG. 2 and FIG. 3, in the open position, lower door section 16 moves downward into threshold 13 and clear of door frame 12. Referring to FIG. 4 and FIG. 5, there is shown how it is preferred that an upper edge 28 of lower door section 16 becomes part of a travel portion 30 of threshold 13 when lower door section 16 is in the open position. Referring to FIG. 2, upper door section 14 and lower door section 16 are independently operable to enable lower door section 16 to remain in the open position while upper door section 14 remains in the closed position. This enables enable small aircraft, vehicles, equipment and supplies to be moved in and out of an aircraft hangar while preventing excessive amounts of warm air from leaving aircraft hangar. When a large aircraft, tall piece of equipment or additional height clearance is required, upper door section 14 may be opened in addition to lower door section 16. When both upper door section 14 and lower door section 16 are in the closed position, door structure 10 is very secure.

### Operation:

Referring to FIG. 1, door structure 10 replaces conventional overhead doors. When installed, it does not add any additional load or stresses to a building, such as an aircraft hangar. When both upper door section 14 and lower door section 16 are in the closed position, door frame 12 provides a seal that provides some weatherproofing for door structure 10. As with conventional overhead doors, weather stripping or other sealing products may be used to improve weatherproofing of door structure 10. Referring to FIG. 2, upper door section 14 and lower door section 16 are movable independently of each other. Lower door section 16 moves downward along lower door guide track 22 and is preferably retractable into threshold 13 to allow access to lower portion 24 of door frame 12. Rather than leave a gap in threshold 13, upper edge 28 of lower door section 16 becomes part of travel surface 30 of threshold 13. Referring to FIG. 3, upper door section 14 moves in an upward direction along upper door guide track 18 to allow access to upper portion 20 of door frame 12.

Upper door section 14 and lower door section 16 may be movable by hydraulic means 26, however it will be understood that mechanical means such as a gear and chain assembly may also be used. Electronic actuators and automation of movement as known in relation to conventional overhead doors may be used to open and close upper door section 14 and lower door section 16.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the preferred embodiments set forth in the examples, but should be given a broad purposive interpretation consistent with the description as a whole.

What is claimed is:

1. A door structure, comprising:
a door frame having a threshold;
an upper door section;
a lower door section;
an upper door guide track guiding movement of the upper door section between a closed position enclosing an upper portion of the door frame and an open position moved upwardly clear of the door frame;
a lower door guide track guiding movement of the lower door section between a closed position enclosing a lower portion of the door frame and an open position moved downwardly retracting into the threshold clear of the door frame; and
the upper door section and the lower door section being independently operable to enable the lower door section to remain in the open position while the upper door section remains in the closed position.

2. The door structure of claim 1, wherein an upper edge of the lower door section becomes a travel portion of the threshold when in the open position.
